(19) United States
(12) Patent Application Publication
(10) Pub. No.: US 2012/0254049 A1
(43) Pub. Date: Oct. 4, 2012

(54) METHOD AND SYSTEM FOR PERFORMING COMPLIANCE CHECKING OF DIRECT SHIPMENT OF WINES

(76) Inventor: Jason Paul Eckenroth, Boulder, CO (US)

(21) Appl. No.: 13/493,785

(22) Filed: Jun. 11, 2012

Related U.S. Application Data
(63) Continuation of application No. 11/972,400, filed on Jan. 10, 2008, now abandoned.
(60) Provisional application No. 60/880,271, filed on Jan. 12, 2007.

(51) Int. Cl. G06Q 10/08; G06Q 99/00

(52) U.S. Cl. 705/317

(57) ABSTRACT

A method of compliance checking includes defining a set of rules related to shipping alcohol to a region. Compliance checking is performed by determining if a shipping client associated with a plurality of shipping orders is compliant with each of the set of rules when executing a plurality of shipping orders to the region. Further, an indication is given indicating whether the client is compliant with the set of rules in relation to execution of the plurality of shipping orders.

### CROSS REFERENCE TO RELATED APPLICATIONS

The present application is a continuation of U.S. application Ser. No. 11/972,400, entitled “Method and System for Performing Compliance Checking of Direct Shipment of Wines,” filed on Jan. 10, 2008, which application claims priority to and the benefit of U.S. Provisional Application No. 60/880,271, entitled “Method and System for Performing Compliance Checking of Direct Shipment of Wines,” filed on Jan. 12, 2007, which applications are herein incorporated by reference in their entirety.

### BACKGROUND OF THE INVENTION

1. Field of Invention

The present invention relates to the field of shipping alcoholic beverages. Specifically, the present invention relates to the automated process of performing compliance checking with regards to numerous rules regulating the shipping of alcoholic beverages.

2. The Relevant Technology

The wine industry has grown to include many different types of wineries that cater to varying wine consumers. Major wineries that may produce hundreds of thousands of bottles of wine of varying varieties compete for wine consumers with smaller wineries that may only produce small hundreds of bottles of wine of one or two varieties.

One evolution of the wine industry includes direct shipping of wine to the consumer. For example, large and small wineries hold open houses for wine tasting in the interest of introducing their wine to the consumer. Sales completed at the open houses may include the shipment of the wine to the consumer directly from the winery to the consumer's home address. In another example, consumers can order and purchase wines through various means (e.g., mail, phone, internet, etc). These purchases are made through various methods, including directly from a particular winery, through wine clubs, through wine retailers or wine clearing houses, as examples. In these cases, shipment of the ordered wines is also made directly to the consumer's home address.

Regulation of direct shipping of wines is extremely complex. Shipping regulations are determined and enforced by each individual state in the United States, as an example. In addition, direct shipping legislation in the United States is different from state to state. Some states exclude direct shipping, but are considering future shipment of wines. Other states allow for instate shipping of wines but exclude out of state shipment of wines to consumer's within that state. Still other states allow for instate and out of state shipment of wines, but include various limits for the shipment of wine on a per customer and total volume basis.

Keeping up to date with the numerous regulations set forth by the various fifty states in the United States is a daunting task. Ensuring that each shipment of wines does not violate any corresponding rules or regulations can hold extreme risks. One or more violations of a particular states shipping rules and regulations may result in the loss of rights to ship to consumers in that state. As a result, as the volume of direct shipping sales is expected to increase over the coming years, both large shipping outfits and smaller shipping outfits will need to invest more time and resources to the task of ensuring that rules and regulations regulating shipment of wines to each state are not violated.

### SUMMARY OF THE INVENTION

A method for compliance checking that enables direct shipping of wine and alcohol to customers while ensuring compliance with state rules and regulations for in state and out of state shipping of alcohol is described. The method includes defining a set of rules related to shipping alcohol to a region. Compliance checking is performed by determining if a shipping client associated with a plurality of direct shipping orders is compliant with each of the set of rules when executing the plurality of shipping orders to the region. Further, an indication is given indicating whether the client is compliant with the set of rules in relation to execution of the plurality of shipping orders. In some embodiments, the method for compliance checking is implemented within the context of a web-based service.

In other embodiments, a method of compliance checking allows for ensuring compliance with state rules and regulations for direct shipping of an order of wine. The method includes receiving an order for shipping wine to an address of a customer. A set of rules is determined that regulates the shipment of wine to the address. Compliance checking is performed by determining if the order is compliant with each of a set of rules related to shipping wine to the address. Further, an indication is given indicating whether the order is compliant with each of the set of rules.

In still other embodiments, a method of compliance reporting includes the automatic generation of various reports related to the direct shipping of alcohol (e.g., direct shipping reports, excise tax reports, sales tax reports, etc.) thereby reducing the need to manually fill out each of the lengthy reports. The method includes collecting a plurality of shipped orders for alcohol by a client to a plurality of customers. Information is collected from the plurality of shipped orders. Reports are listed, wherein the reports are required by agencies which regulate the shipment of alcohol. Compliance reporting is enabled such that in response to a selection of one of the listed reports, information is pre-populated in the report based on the information that is collected.

### BRIEF DESCRIPTION OF THE DRAWINGS

Exemplary embodiments are illustrated in referenced figures of the drawings which illustrate what is regarded as the preferred embodiments presently contemplated. It is intended that the embodiments and figures disclosed herein are to be considered illustrative rather than limiting.

FIG. 1 is a block diagram of a system for compliance checking, in accordance with one embodiment of the present invention.

FIG. 2 is an exemplary user interface for compliance checking, in accordance with one embodiment of the present invention.

FIG. 3 is a flow diagram illustrating a method for compliance checking, in accordance with one embodiment of the present invention.

FIG. 4 is an illustration of a tool for indicating compliance with rules regulating direct shipping of wines in the United States of America, in accordance with one embodiment of the present invention.

FIG. 5 is an illustration of a tool showing non-compliance with rules regulating direct shipping of wines for the state of Nebraska, in accordance with one embodiment of the present invention.

FIG. 6A is an illustration of a tool for indicating compliance with rules regulating direct shipping of wines for the state of Nevada, in accordance with one embodiment of the present invention.

FIG. 6B is an illustration of a tool for indicating status of compliance with rules regulating direct shipping of wines for the state of Nevada, in accordance with one embodiment of the present invention.

FIG. 6C is an illustration of a tool providing explanations of compliance status of rules regulating direct shipping of wines for the state of Nevada, in accordance with one embodiment of the present invention.

FIG. 7 is a flow diagram illustrating a method for compliance checking of an order for the shipment of wine, in accordance with one embodiment of the present invention.

FIG. 8 is a flow diagram illustrating a process for compliance checking of an order for shipping wine, in accordance with one embodiment of the present invention.

FIG. 9 is an illustration of a tool for providing verification of addresses in an order for the direct shipping of wine, in accordance with one embodiment of the present invention.

FIG. 10 is an illustration of a tool for indicating compliance with rules regulating shipment of wine, in accordance with one embodiment of the present invention.

FIG. 11A is an illustration of a tool for showing alerts related to compliance of rules regulating direct shipping of wines, in accordance with one embodiment of the present invention.

FIG. 11B is an illustration of a tool for defining parameters for associated alerts, in accordance with one embodiment of the present invention.

FIG. 12 is a flow diagram illustrating a method for automatically generating reports related to the shipment of alcohol, in accordance with one embodiment of the present invention.

FIG. 13A is a tool illustrating a list of reports related to direct shipping of alcohol, in accordance with one embodiment of the present invention.

FIG. 13B is a report related to direct shipping of alcohol, in accordance with one embodiment of the present invention.

FIG. 13C is a tool illustrating filing instructions for the report of FIG. 13B, in accordance with one embodiment of the present invention.

### DETAILED DESCRIPTION OF THE PREFERRED EMBODIMENTS

Reference will now be made in detail to the preferred embodiments of the present invention, a method and system for compliance checking of rules regulating the direct shipping of wine. While the invention will be described in conjunction with the preferred embodiments, it will be understood that they are not intended to limit the invention to these embodiments. On the contrary, the invention is intended to cover alternatives, modifications and equivalents which may be included within the spirit and scope of the invention as defined by the appended claims.

Accordingly, embodiments of the present invention provide for automatic compliance checking of rules regulating the direct shipping of alcohol (e.g., wine). In addition, other embodiments of the present invention provide for automatic generation of reports required by regulating agencies that are related to the direct shipping of alcohol (e.g., wine). Still other embodiments provide for the generation of alerts for alerting when reports are due, licenses are up for renewal, volume totals are approaching limits, regulatory changes occur, etc.

Embodiments of the present invention are described within the context of a web-based system for performing compliance checking of shipping orders related to wine and alcohol. That is, a web-based service is disclosed for providing compliance checking of rules regulating the sale and direct shipping of wine and alcohol. As such, web-based services allows for the automatic import of orders in real-time or otherwise over the internet, or other network in order to perform compliance checking of each of the orders. Other embodiments are well suited to implementing the compliance checking system on a stand-alone system, such as a computer, etc.

### 1. Notation and Nomenclature

Embodiments of the present invention can be implemented on software running on a computer system. The computer system can be a personal computer, notebook computer, server computer, mainframe, networked computer, handheld computer, personal digital assistant, workstation, and the like. This software program is operable for providing targeted data delivery. In one embodiment, the computer system includes a processor coupled to a bus and memory storage coupled to the bus. The memory storage can be volatile or non-volatile and can include removable storage media. The computer can also include a display, provision for data input and output, etc.

Some portion of the detailed descriptions that follow are presented in terms of procedures, steps, logic block, processing, and other symbolic representations of operations on data bits that can be performed on computer memory. These descriptions and representations are the means used by those skilled in the data processing arts to most effectively convey the substance of their work to others skilled in the art. A procedure, computer executed step, logic block, process, etc. is here, and generally, conceived to be a self-consistent sequence of operations or instructions leading to a desired result. The operations are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “defining,” “determining,” “indicating,” “receiving,” or the like refer to the actions and processes of a computer system, or similar electronic computing device, including an embedded system, that manipulates and transfers data represented as physical (electronic) quantities within the computer system's registers and memories into other data similarly represented as physical quantities within the computer system memories or registers or other such information storage, transmission or display devices.

### 2. General System for Compliance Checking of Rules Regulating Direct Shipping of Alcohol

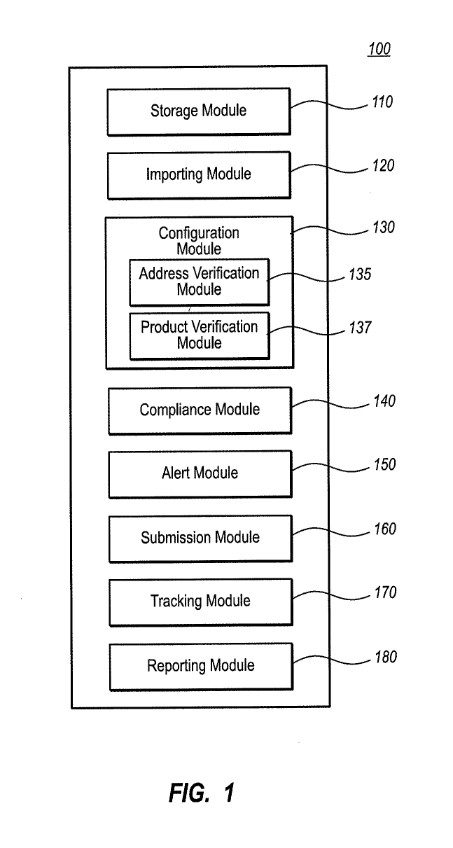

FIG. 1 is a block diagram of a compliance system 100 for compliance checking, in accordance with one embodiment of the present invention. Compliance system 100 is used to ensure that all orders for the shipment of alcohol (e.g., wine) is in compliance with various rules defining regulations related to the direct shipping of alcohol. For instance, compliance system 100 is used to ensure compliance with the complex web of state regulations regulating the direct shipping of alcohol, in one embodiment.

Embodiments of the present invention are directed to the direct shipment of alcohol. However, for purposes of brevity and clarity, throughout the specification, the direct shipping of wine is provided as an example of the direct shipping of alcohol. It is intended that examples illustrating the direct shipping of wine in relation to embodiments of the present invention are also well suited to the direct shipping of various other types of alcohol as implemented through embodiments of the present invention.

Compliance system 100 includes a storage module 110 that provides a comprehensive rules engine. Storage module 110 stores all of the rules that define the various state regulations related to the direct shipping of alcohol. In one embodiment, the rules within storage module 110 can be updated continuously as regulatory changes occur. In addition, compliance system 100 is capable of adding rules to storage module 110 as the rules come into effect.

Additionally, storage module 110 is capable of storing other items necessary for ensuring compliance with the rules. For instance, storage module 110 stores step by step instructions for becoming compliant with rules in each of the direct shipping states. Also, storage module 110 is capable of storing orders placed for the direct shipping of alcohol to customers, invoices based on the orders, and reports to states related to the orders. Additionally, storage module 110 is capable of storing required reporting information gathered from orders placed for the direct shipping of alcohol. Further, storage module 110 is capable of storing templates of reports that are pre-populated with reporting information, in one embodiment. Also, storage module 110 is capable of storing thresholds for alerts that help with the compliance of the rules defining state regulations of the direct shipping of alcohol.

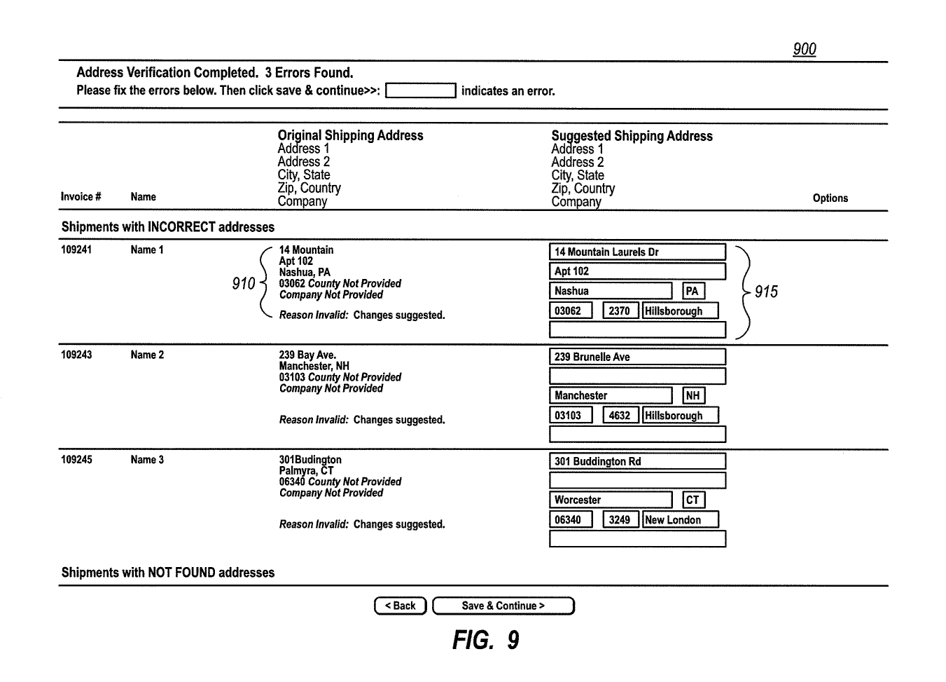

System 100 also includes an importing module 120. The importing module 120 provides for order entry within compliance system 100. For instance, importing module 120 provides for manual entry of orders. In addition, importing module 120 provides for batch entry of orders, as will be described more fully below in the discussion related to FIG. 9.

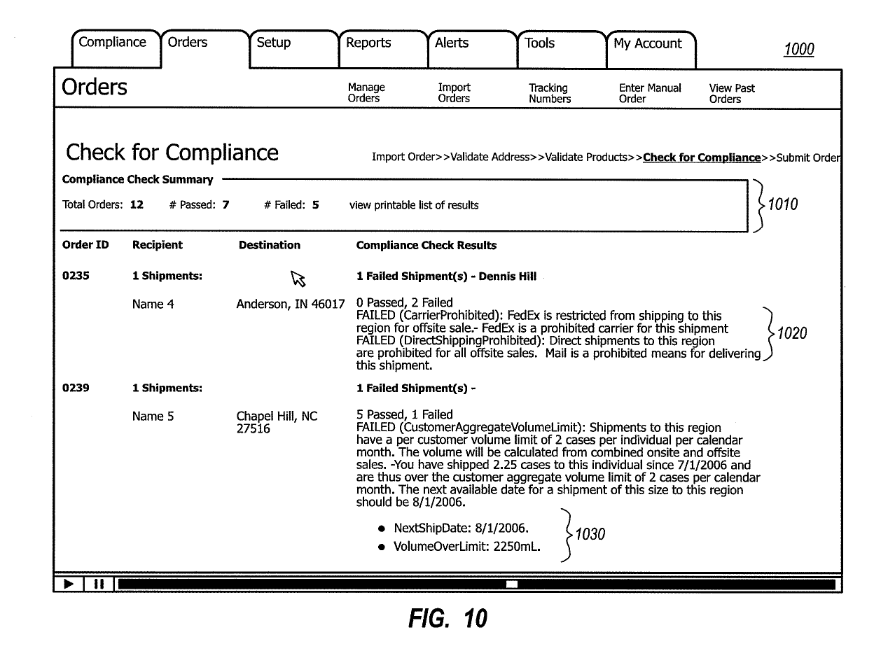

System 100 also includes a confirmation module 130 that is comprised of an address verification module 135 and a product verification module 137. Confirmation module 130 is used to find the corresponding rules that govern the direct shipping of an order. In particular, because rules can be based on counties of states, the shipping address is vital for determining the county which specifies the rules governing the shipment of the order. As such, the address verification module 135 is used to validate the address on an order. In addition, the confirmation module 130 verifies the products being shipped in the order through the use of product verification module 137. Confirmation module 130 is more fully described below in the discussion related to FIG. 10.

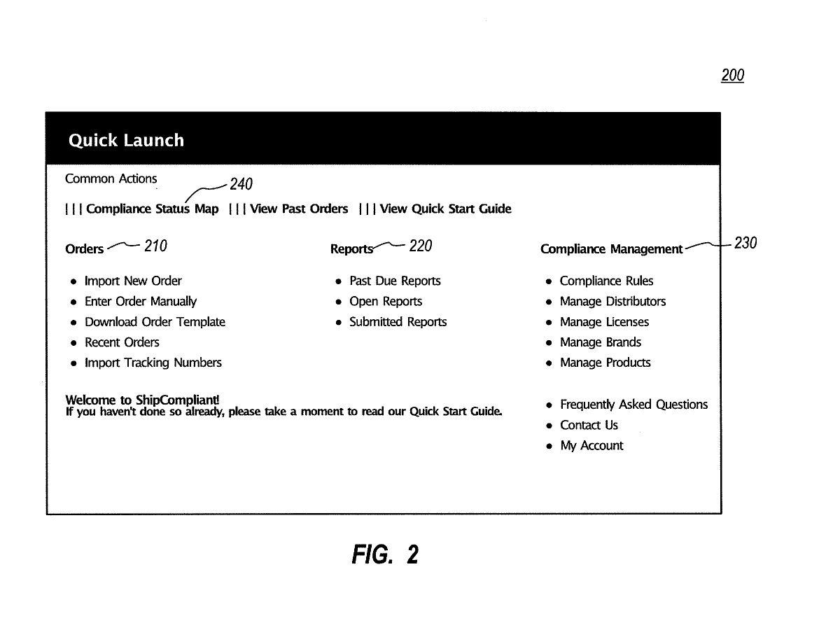

A compliance module 140 is included within compliance system 100. Compliance module 140 ensures that individual orders for the direct shipment of alcohol satisfy or are in compliance with the rules defining and regulating the shipment of alcohol to the various states. Compliance module 140 is described more fully below in the discussion related to FIGS. 2, 4, 5, and 6A-C.

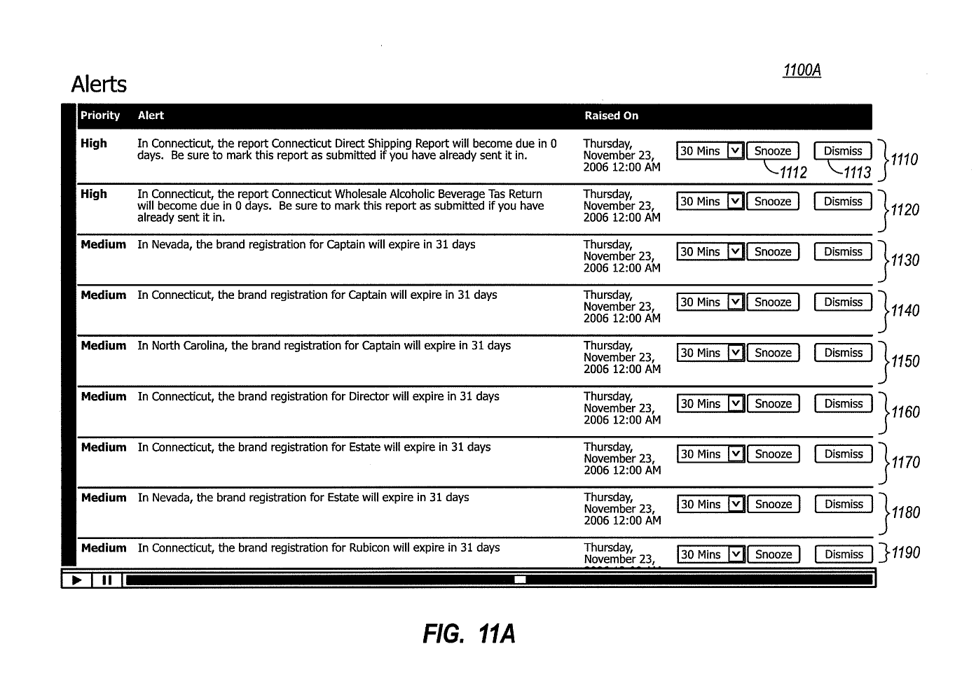

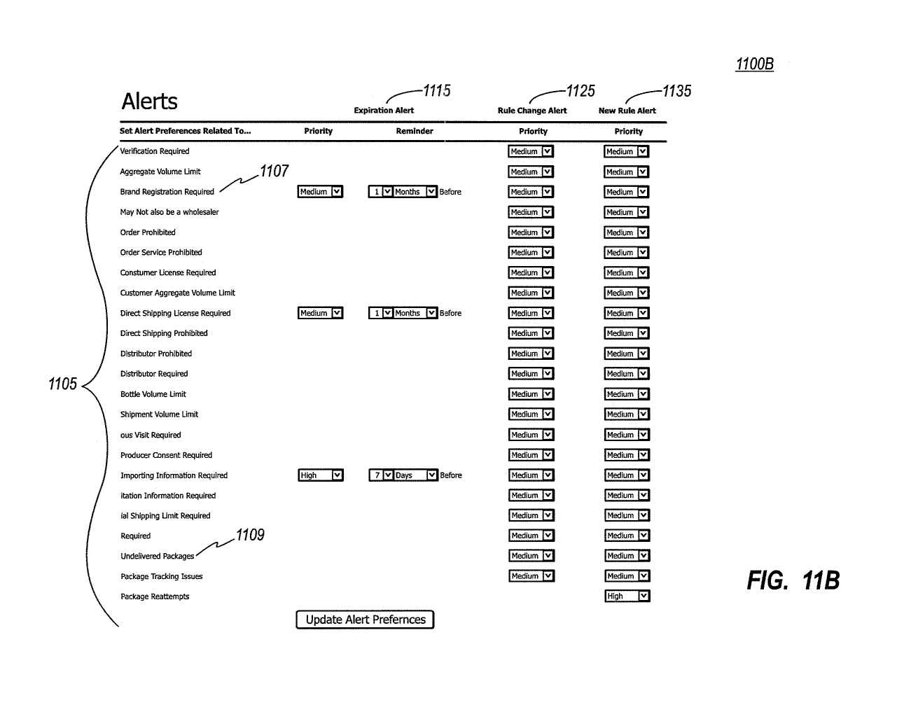

Compliance system 100 also includes an alert module 150 that provides alerts. The alerts provide reminders to complete tasks, or provide information. For instance, the alerts indicate which licenses are about to expire, which brand registrations are about to expire, which reports are coming due, which new rules take effect, when rules have changed, when volume limits are approaching their limits, when packages have returned, etc. Alerts are discussed more fully below in the discussion related to FIGS. 11A and 11B.

A submission module 160 in compliance system 100 allows for orders to be submitted after compliance checking has been successfully completed. In that case, submitted orders can be executed for direct shipping to the consumer.

Compliance system 100 also includes a tracking module 170. After the order is shipped to an address of a consumer, tracking module is capable of tracking the progress of the order. In one embodiment, each step of the shipping process is tracked. Specifically, tracking module interfaces directly with package shipping companies to gather tracking information. This tracking information is used to track the order, and to determine if the order was successfully shipped, and if not, at what stage is the shipping process present. The tracking process is more fully described below.

Compliance system 100 also includes a reporting module 180. Reporting module provides for the automatic pre-population of reports that are required by the regulating agencies of states that are related to the direct shipping of alcohol to residents of those states. The reports are automatically filled out with compliance information gathered from each of the orders. In one embodiment, the reports are ready for signature and ready to be sent off to the corresponding state.

FIG. 2 is an exemplary user interface 200 that is used for compliance checking, in accordance with one embodiment of the present invention. As shown in FIG. 2, user interface 200 is used to access various features that are implemented by compliance system 100. For instance, user interface 200 provides a launching site to access the orders feature 210, the reports feature 220, and the compliance management feature 230 provided in embodiments of the present invention.

Specifically, by selecting the orders feature 210, new orders for direct shipment of alcohol can be imported or entered manually into compliance system 100 and be checked for compliance with rules regulating the shipment of alcohol. Additional services are provided such as, accessing order templates, viewing recent orders, and import tracking numbers, etc.

By selecting the reports feature 220, past due reports are alerted and are automatically prepared for signing and submission to the proper authorities. Additionally, reports can be opened for review, and further editing. Also, submitted reports can be accessed.

By selecting the compliance management feature 230, various management tools are accessed for ensuring that rules related to the direct shipping of alcohol are complied with. For instance, under the compliance management feature 230, compliance rules can be accessed, and edited if necessary. Also, the management tools include means for managing distributors, licenses, brands, and products.

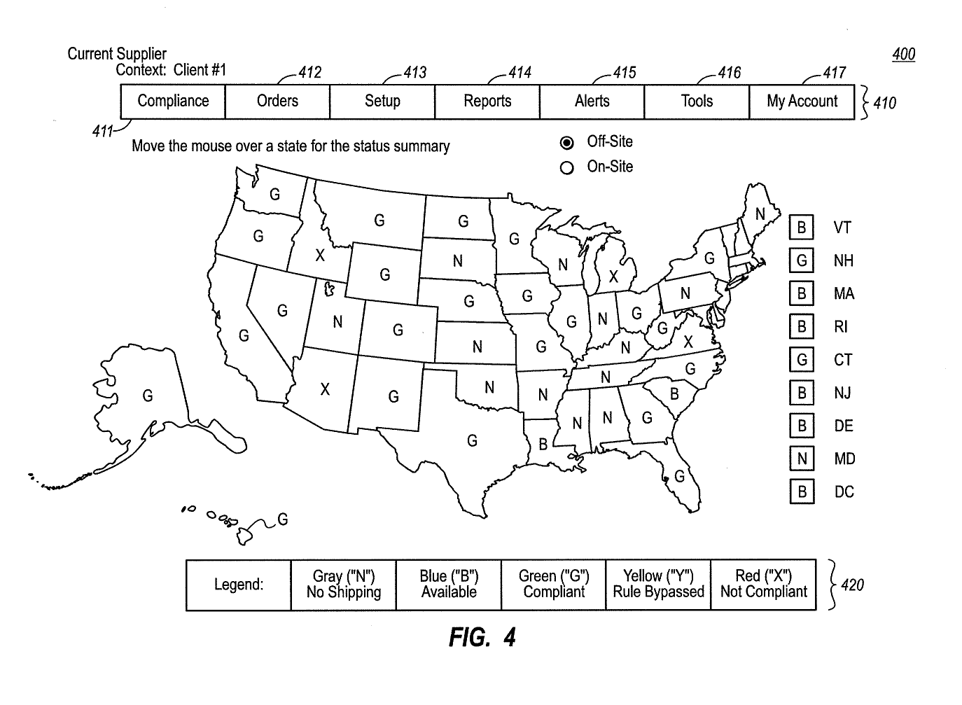

In addition, user interface 200 is used to access other features provided by compliance system 100. For instance, selection of the compliance status map feature 240 enables access to a map that indicates the compliance status of a shipping client in relation to different regions (e.g., various states in the United States). The compliance status map feature 240 is more fully described in relation to FIGS. 4, 5, and 6A.

### 3. Method of Performing Compliance Checking for a Shipping Client

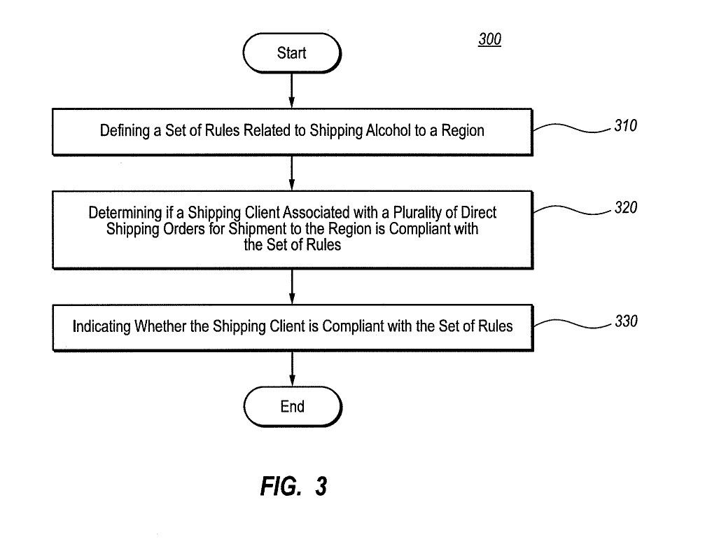

FIG. 3 in combination with FIGS. 1, 2, 4, 5, 6A, 6B, and 6C illustrate a process for ensuring compliance with rules defining regulations for shipping alcohol to various states in the United States, in accordance with embodiments of the present invention. In particular, FIG. 3 is a flow diagram illustrating a method for compliance checking, in accordance with one embodiment of the present invention. FIGS. 4, 5, 6A, 6B, and 6C illustrate various tools for implementing the compliance checking described in FIG. 3.

Although embodiments of the present invention are directed to compliance checking of alcohol to states within the United States, other embodiments of the present invention are well suited to compliance checking of rules related to direct shipping of alcohol to any general region that is not specific to any state of the United States.

Now turning to FIG. 3, flow diagram 300 illustrates a method for compliance checking that ensures direct shipping orders that are associated with a shipping client is compliant with each of the rules regulating the direct shipment of alcohol to customers, in accordance with one embodiment of the present invention. The method of flow diagram 300 is implemented to mitigate the risks of direct shipping by seamlessly managing the entire spectrum of rules regulating the direct shipping of alcohol and ensuring that orders for direct shipping are compliant with the rules. In one embodiment, the method of FIG. 3 is implemented automatically in order to efficiently provide compliance checking of the shipment of alcohol.

At 310, the method of flow diagram 300 begins by defining a set of rules related to shipping alcohol to a region. Specifically, in one embodiment the rules define regulations legislated by each of the states in the United States of America (United States) that regulate the direct shipping of alcohol. For instance, each rule is legislated by a corresponding state, and regulates shipment of alcohol to that corresponding state. In one embodiment, the set of rules define regulations related to the shipping of wine.

In one embodiment, the region is defined as a state. In general, each state regulates the direct shipping of alcohol to persons residing within the corresponding state. That is, each state regulates the direct shipping of alcohol to persons with shipping addresses in the corresponding state. As such, the method of flow diagram 300 defines the set of rules related to shipping alcohol to specific states.

In still another embodiment, the region is defined as a county within a state. Counties may provide further regulations that stipulate how direct shipping of alcohol is applied to residents of that county. As such, the method of flow diagram 300 defines the set of rules related to shipping alcohol to specific counties and other jurisdictions.

The regulations are interpreted by industry experts and are implemented within the method of flow diagram 300 as rules, in one embodiment. That is the rules are specified for inclusion within the compliance system 100, and are associated with regulations provided by state legislatures for regulating the direct shipping of alcohol. In another embodiment, the set of rules is stored in the storage module 110 of compliance system 100. In still another embodiment, the comprehensive set of rules in the storage module 110 is updated continuously. That is, as legislation is enacted by each of the states, affected rules in the set of rules are modified or updated and stored in storage module 110. In addition, new rules resulting from the legislation are added to the set of rules and are stored in storage module 110.

In one embodiment, the set of rules is directed to onsite direct shipping orders. Specifically, onsite orders are placed by a customer at a physical location, such as a winery, a retail store, etc. In another embodiment, the set of rules is directed to offsite direct shipping orders. Specifically, offsite orders are placed by a customer that is remotely located from the location that is handling the order. Some examples of the placement of offsite orders are orders taken over the phone or internet, orders taken through a wine club, etc.

At 320, the method of the present embodiment determines if a plurality of direct shipping orders for shipment to the region is compliant with each of the set of rules. The plurality of direct shipping orders is associated with a shipping client. In particular, the shipping client executes each of the direct shipping orders. Compliance checking can be implemented in any manner, including performing compliance checking for each individual order as received, in one embodiment, or by performing compliance checking for a batch of orders, in another embodiment.

More specifically, at 320, the method of the present embodiment determines that the shipping client is in compliance with the set of rules when the plurality of direct shipping orders executed by the shipping client is compliant with corresponding rules in the set of rules. In addition, the method of the present embodiment determines that the shipping client is not in compliance with the set of rules if one of the plurality of shipping orders is not compliant with one of the set of rules. As such, the method of the present embodiment is capable of determining which rules the shipping client is in compliance, and which rules the client is not in compliance.

At 330, the method of the present embodiment provides an indication whether the shipping client is compliant with the set of rules that relate to the execution of the plurality of shipping orders for the direct shipment of alcohol. Specifically, the compliance status of the shipping client is indicated in relation to the execution of the plurality of direct shipping orders to the specified region. Specific examples of the implementation of indicating the compliance status is provided in the discussion related to FIGS. 4, 5, 6A, 6B, and 6C.

More particularly, the compliance check performed at 330 is a complete check for compliance of all of the sales orders associated with the shipping client. Based on the destination addresses of each shipment, the present embodiment is capable of determining all of the rules that are applicable, and checks each shipment for compliance with each of the applicable rules, one rule at a time, in one embodiment. In another embodiment, the compliance check is performed in real time, at the time of the creation of the sales order by nature of integrations via the System's application programming interface (API) web services. In still another embodiment, the compliance check is performed after the fact; that is, after some time period from the creation of the sales order.

In one embodiment, the method of the present embodiment determines if the shipping client is compliant with the set of rules when executing a plurality of onsite direct shipping orders. That is, compliance is directed specifically to onsite direct shipping orders. As such, the compliance status of the shipping client is indicated in relation to the execution of a plurality of onsite shipping orders.

In another embodiment, the method of the present embodiment determines if the shipping client is compliant with the set of rules when executing a plurality of offsite direct shipping orders. That is, compliance is directed specifically to offsite direct shipping orders. As such, the compliance status of the shipping client is indicated in relation to the execution of a plurality of offsite shipping orders.

In another embodiment, the method outlined in flow chart 300 can be implemented to perform compliance checking for more than one region. For example, the method outlined in flow chart 300 can be implemented to perform compliance checking for one or more states in the United States. As such, the method of flow chart 300 in the present embodiment includes defining at least one rule in said set of rules that is related to shipping alcohol to another region, a second region. Thereafter, the method of the present embodiment determines if the shipping client is compliant with the at least one rule when executing direct shipping orders to the second region. Also, the method outlined in the present embodiment is capable of indicating whether the shipping client is compliant with the at least one rule.

As such, the method of the present embodiment is capable of independently indicating whether the shipping client is compliant with rules for direct shipping of alcohol related to different regions. For instance, the method of the present embodiment is capable of indicating whether the shipping client is compliant with corresponding rules for direct shipping alcohol to a first region (e.g., a first state), and separately indicating whether the shipping client is compliant with corresponding rules for direct shipping of alcohol to a second region (e.g., a second state).

FIG. 4 is an illustration of a tool for indicating compliance with rules regulating the direct shipping of wines for states in the United States of America, in accordance with one embodiment of the present invention. More specifically, as shown in FIG. 4, a compliance status map 400 gives an indication of the compliance status of a shipping client for each of a plurality of specified regions (e.g., a plurality of states in the United States) in relation to the set of rules defining regulations for direct shipping of alcohol to each of the states in the United States.

In addition, tool bar 410 provides access to other features provided by the compliance system 100. For example, tool bar 410 provides access to Compliance feature 411, Orders feature 412, Setup feature 413, Reports feature 414, Alerts feature 415, Tools feature 416, and My Account feature 417.

Compliance status map 400 provides an indication as to the compliance of the rules defining regulations for direct shipping of alcohol that are specific to each state. Specifically, compliance status map 400 provides a visual representation of the compliance of the shipping client in relation to executed direct shipping orders to the various states in the United States.

In particular, the compliance status map 400 gives a visual representation of the compliance status of a specific shipping client. As a generic example, compliance status map 400 is prepared for Client #1. More particularly, compliance status map 400 indicates whether Client #1 when executing a plurality of shipping orders is compliant with each state's direct shipping regulations.

Further, as shown in FIG. 4 compliance status map 400 is prepared specifically for offsite shipping orders. That is, compliance status map 400 indicates whether Client #1, when executing a plurality of offsite direct shipping orders, is compliant with direct shipping regulations for each state, at a certain point in time.

In another embodiment, another compliance status map can be prepared specifically for onsite shipping orders. That is, the new compliance status map indicates whether Client #1, when executing a plurality of onsite direct shipping orders, is compliant with direct shipping regulations for each state.

In one embodiment, compliance status map 400 illustrates a color coded representation of the compliance status of the shipping client. That is, each of the states are colored according to their compliance status. Smaller states or regions (e.g., Vermont, New Hampshire, Massachusetts, Rhode Island, Connecticut, New Jersey, Delaware, Maryland, and the District of Columbia) have a separately coded block that indicates the compliance status.

Since color is not provided in FIG. 4, letter designations for each of the colors are shown. For instance, tool bar 420 provides a legend for the compliance status of each letter designation. In particular, the letter N represents the color gray, and indicates that no shipping of alcohol is allowed for that state. For example, the state of Utah does not allow for shipment of alcohol, as per compliance status map 400. Also, the letter B represents the color blue and indicates that shipping of alcohol is allowed for that state, although Client #1 may not be currently shipping to that state. For instance, Louisiana allows shipment of alcohol. The letter G represents the color green, and indicates that Client #1 is compliant with the rules for direct shipment of alcohol to the corresponding state. For example, Client #1 is compliant with the Nevada rules for direct shipping of alcohol. The letter Y represents the color yellow, and indicates that the rules for that state have been bypassed. The letter X represents the color red, and indicates that Client #1 is not compliant with the rules for direct shipment of alcohol to the corresponding state. For example, Client #1 is not compliant with the Nebraska rules for direct shipping of alcohol.

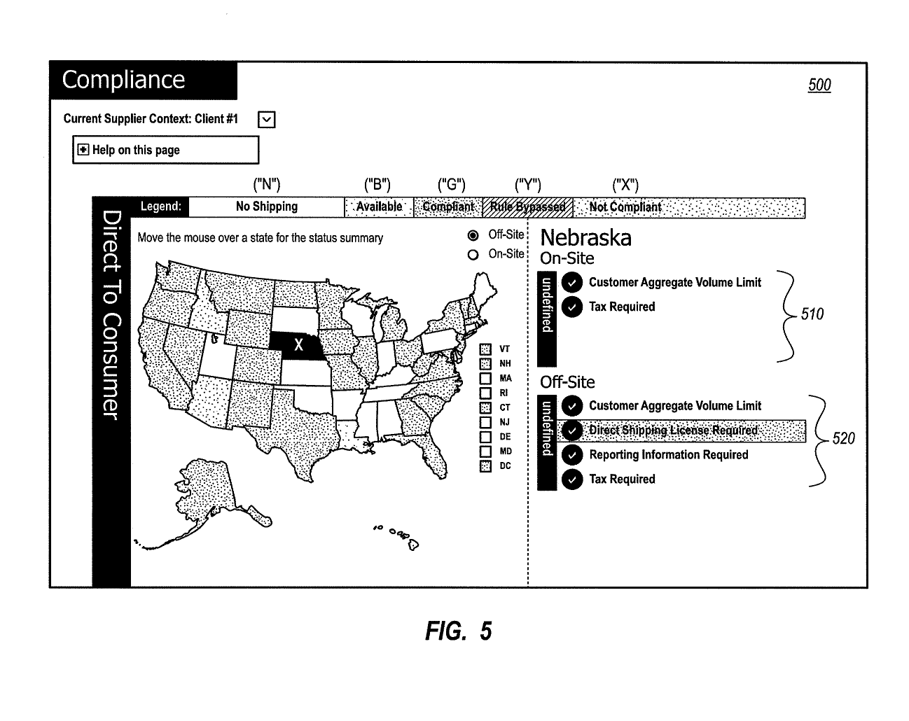

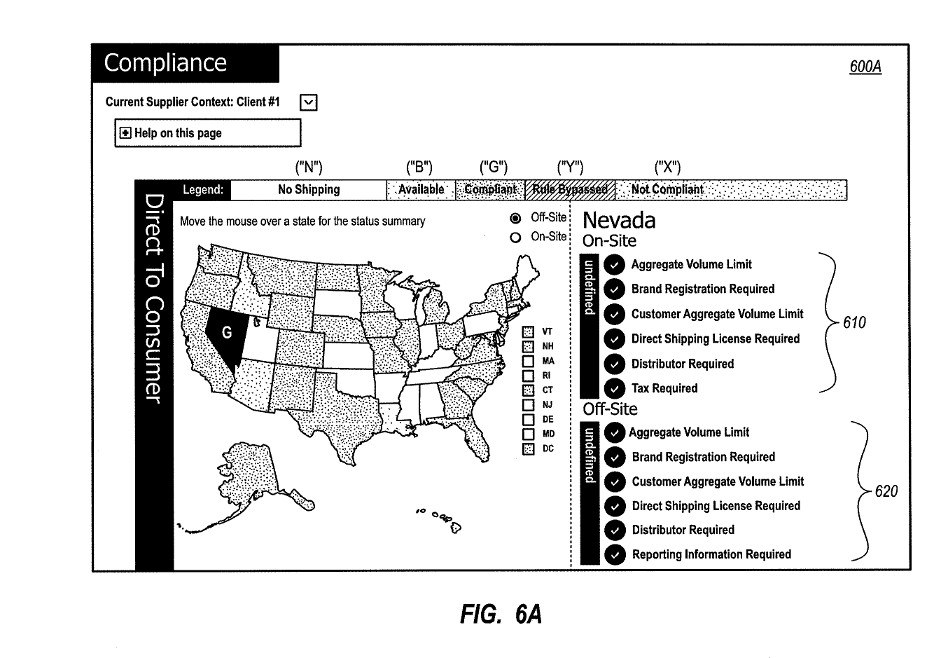

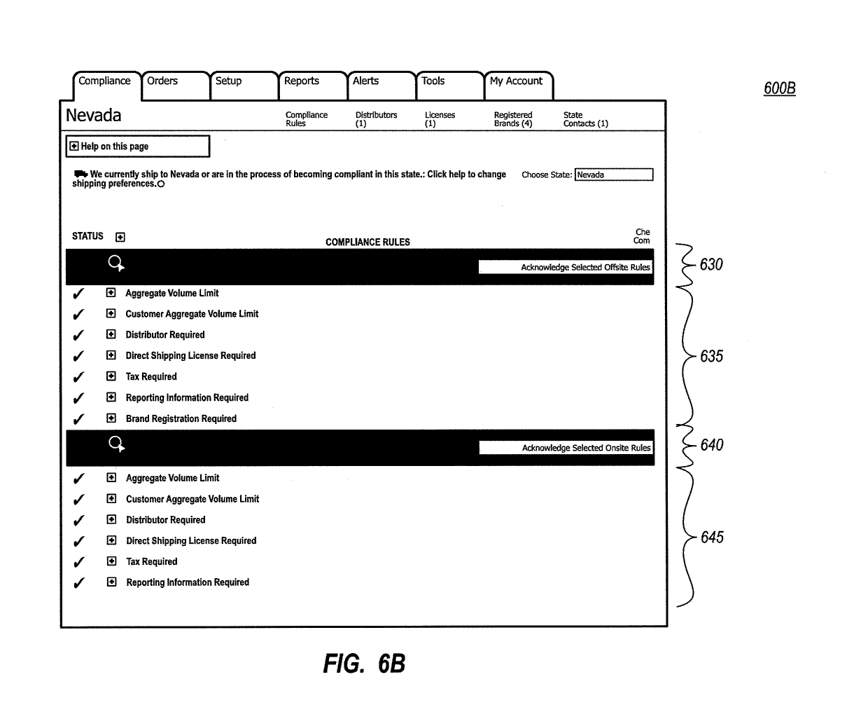

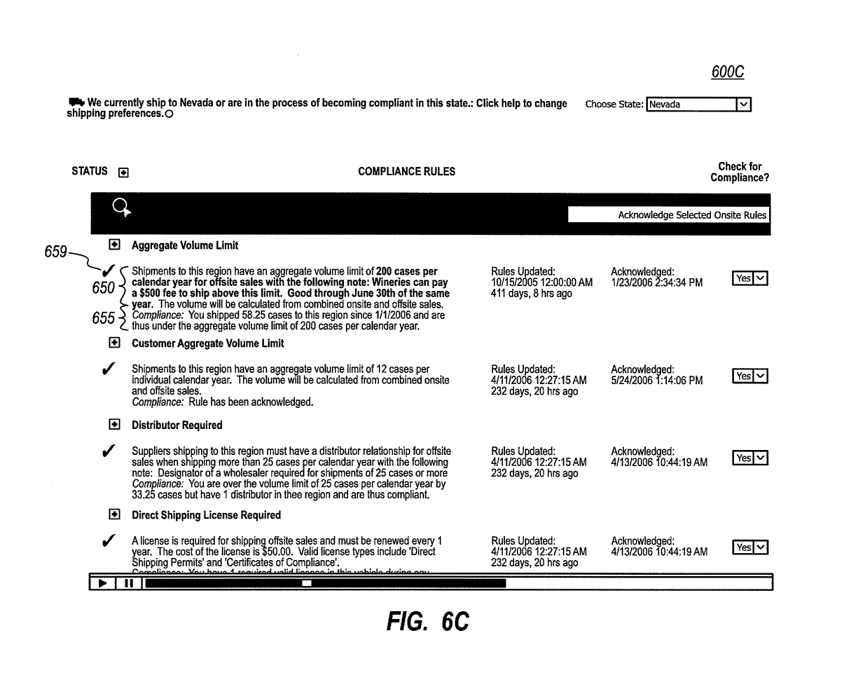

Additionally, a more detailed compliance status summary is provided by selecting a particular state (e.g., using a mouse). For example, FIGS. 5 and 6A provide summaries of a compliance status and a non-compliance status of Client #1 for two states. As shown in FIGS. 5 and 6A, a side bar lists the rules that Client #1 is in compliance for the corresponding state. In addition, a side bar lists the rules that Client #1 is not in compliance for the corresponding state.

In particular, a summary of the compliance status for Nebraska is presented in FIG. 5. As shown, Client #1 is not compliant with the rules defining the direct shipment of alcohol to Nebraska. Specifically, as shown in side bar 510 FIG. 5, Client #1 is compliant with applicable onsite shipping rules in Nebraska. However, as shown in side bar 520 Client #1 is not compliant with one or more rules for offsite shipping in the state of Nebraska. While Client #1 is compliant with most of the rules for offsite shipping, Client #1 is not compliant with the rule requiring a direct shipping license. That is, Client #1 needs to submit a direct shipping license to the state of Nebraska.

In addition, a summary of the compliance status for Nevada is presented in FIG. 6A. As shown, Client #1 is compliant with the rules defining the onsite and offsite shipping of alcohol to residents of Nevada. For instance, as shown in side bar 610, Client #1 is compliant with one or more rules for onsite shipping. Also, as shown in side bar 620, Client #1 is compliant with one or more rules for offsite shipping.

Furthermore, a more detailed summary of the compliance status of Client #1 for any state can be provided. For instance, a more detailed summary of the compliance status of Client #1 in the State of Nevada is provided in FIG. 6B. In one embodiment, the information in FIG. 6B can be accessed by selecting the enlarged representation of Nevada in FIG. 6A.

As shown in FIG. 6B, the rules applicable for shipping alcohol to Nevada for offsite orders are provided in section 635. In particular, offsite rules governing the shipment of alcohol to residents, or addresses in Nevada, include, but are not limited to, aggregate volume limit for Client #1, customer aggregate volume limit, distributor required, direct shipping license required, tax required, reporting information required, and brand registration required. Information bar 630 indicates that Client #1 is compliant with all rules governing the offsite shipment of alcohol.

In addition, the rules applicable for shipping alcohol to Nevada for onsite orders are provided in section 645. In particular, onsite rules governing the shipment of alcohol to residents, or addresses in Nevada, include, but are not limited to, aggregate volume limit for Client #1, customer aggregate volume limit, distributor required, direct shipping license required, tax required, reporting information required, and brand registration required. Information bar 640 indicates that Client #1 is compliant with all rules governing the onsite shipment of alcohol.

FIG. 6C is an illustration of a tool providing explanations of compliance status of rules regulating direct shipping of wines for the state of Nevada, in accordance with one embodiment of the present invention. Specifically, in the present embodiment, definitions of rules that are listed for each state are also provided. For instance, a definition of each listed rule in FIG. 6A is provided in FIG. 6C.

As an example, the definition of aggregate volume limit rule is provided in section 650 of FIG. 6C. That is, for the state of Nevada, Client #1 can only ship an aggregate volume limit of 200 cases per calendar year for offsite sales. Information that is pertinent to the definition can also be provided, and optionally highlighted. In this case, Client #1 can ship over the aggregate volume limit by purchasing an over limit fee.

As such, the information provided in section 650 shows what Client #1 needs to perform in order to reach or stay in compliance with the corresponding rule. More particularly, step by step instructions are provided (e.g., in section 650) that define the necessary steps needed to become compliant for the corresponding rules in each of the direct shipping states.

Additionally, a compliance status of Client #1 is also provided in relation to the aggregate volume limit rule in section 655. That is, for each rule that is further defined, a textual description of the compliance status of Client #1 for that rule is also provided. For instance, in section 655, Client #1 has only shipped 58.25 cases since the beginning of the year, and is currently in compliance with the total limit of 200 cases as set by the aggregate volume limit rule.

Also, a visual representation of the compliance status through the check symbol 659 provides a compliance status of the aggregate volume limit rule, as an example. As such, for each rule that is further defined, a visual representation of a compliance status of the Client #1 with regards to that rule is also provided.

### 4. Method for Performing Compliance Checking for an Order for the Direct Shipment of Wine

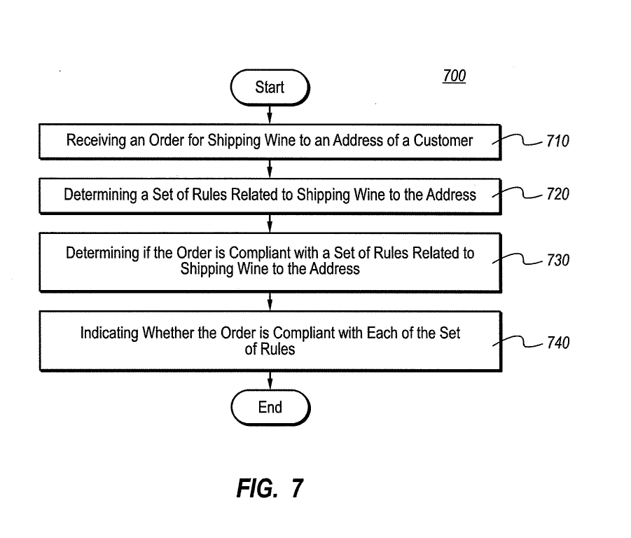

FIG. 7 is a flow diagram 700 illustrating a method for compliance checking of an order for the shipment of wine, in accordance with one embodiment of the present invention. The method of FIG. 7 can be implemented by compliance system 100 of FIG. 1, in one embodiment. In addition, the method of FIG. 7 can be implemented to perform compliance checking of multiple orders for the shipment of wine, in another embodiment. That is, the process outlined in FIG. 7 is repeated each time for each new order in a batch or orders to determine compliance with rules regulating the direct shipment of wine. In one embodiment, the method of FIG. 7 is implemented automatically in order to efficiently provide compliance checking of the shipment of wine.

At 710, the method of flow diagram 700 receives an order for direct shipping of wine to an address of a customer. In one embodiment, the order may comprise an order for onsite direct shipping. In another embodiment, the order may comprise an order for offsite direct shipping.

At 720, in the present embodiment, a set of rules for compliance is determined. The set of rules is related to shipping wine to the customer. Specifically, the direct shipping of wine to the customer is associated with a set of rules as determined by the particular address of the customer. The set of rules may be defined by the state within which the address may be found, in one embodiment. In addition, the set of rules may be further defined by the county of the state within which the address may be found, in another embodiment.

At 730, in the present embodiment, compliance with a set of rules that is related to shipping wine to the address of the customer is determined. As a result, the order is compared to each of the rules applicable to shipping wine to the address of the customer in order to determine compliance of the order. If the order satisfies each of the applicable rules, then the order is in compliance with the set of rules. On the other hand, if the order violates at least one of the set of rules, then the order is not compliant with the set of rules.

More particularly, the compliance check performed at 730 is a complete check for compliance of the sales order. Based on the destination address of the order, the present embodiment is capable of determining all of the rules that are applicable, and checks the order for compliance with each of the applicable rules, one rule at a time. In one embodiment, the compliance check is performed in real time, at the time of the creation of the sales order. In another embodiment, the compliance check is performed after the fact; that is, after some time period from the creation of the sales order.

At 740, in the present embodiment, an indication is given whether the order is compliant with each of the set of rules that are associated with shipping wine directly to the address of the customer. In one embodiment, a visual representation of the compliance status of the order is given, Some examples of visual representations are discussed in relation to FIGS. 4, 5, and 6A. Other embodiments are well suited to visual representations such as check marks, crosses, colors, or other symbols. In another embodiment, the indication of the compliance status is given in textual form. That is, an explanation of the compliance status is given.

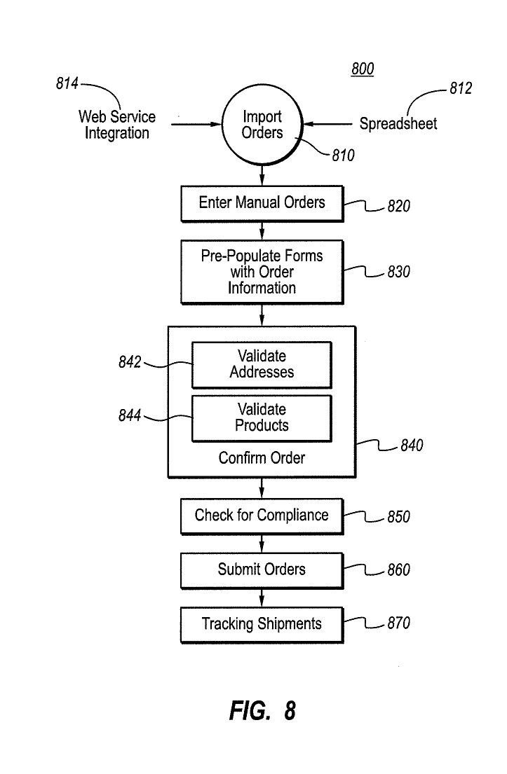

FIG. 8 is a flow diagram 800 that illustrates a process flow for importing one or more orders, performing compliance checking of the orders, and for submitting the orders for the shipment of wine. The process flow of FIG. 8 can be implemented on an order by order basis, or on multiple orders. The process flow of FIG. 8 can be implemented by compliance system 100, in one embodiment. In addition, the process flow of FIG. 8 is capable of implementing the methods of flow diagrams 3000 and 700 of FIGS. 3 and 7, respectively.

As shown in flow diagram 800, orders are imported, in the present embodiment. For example, orders are imported into the compliance system 100 in order to check for compliance with the set of rules governing the shipment of wine to the address contained within the order. Various means for importing the orders can be implemented.

Flow diagram 800 provides for three methods for importing orders. Two methods are utilized to import orders automatically, at 810. One method is used to import orders manually at 820.

Specifically, at 810, orders are imported in a bulk process. Specifically, a bulk import wizard can be utilized to automatically import orders contained within a file, such a spreadsheet 812, or other storage file. The bulk import wizard can be configured to accept all wine industry export formats suitable for existing and future eCommerce, point of sale, and wine club solutions.

In addition, the bulk import wizard can be utilized to automatically import orders through web service integration 814. For instance, a full suite of web services allows for the complete integration of third party wine order management systems. The integration allows for the automatic import of orders in real time over the internet, or other network, into the compliance system 100 of FIG. 1 in order to perform compliance checking of each of the orders. Web service integration provides for accurate and seamless compliance, since the orders are imported within the compliance system 100 in real time, at the point of sale, in one embodiment.

At 820, orders are entered within the compliance system 100 manually. For instance, orders can be entered one at a time using a manual order wizard. Information from previously entered customers can be retrieved for easy importing of new sales orders to that customer.

At 830, information is collected from the orders. For example, this order information includes, name of customer, billing address, shipment address, wine or alcohol ordered, amounts ordered, etc. The information can be used to pre-populate forms and reports, as will be described more fully below. For instance, invoices can be automatically generated by pre-populating the billing invoice with the corresponding information imported from the corresponding sales orders.

At 840, in the present embodiment, orders are confirmed. Specifically, street level validation is performed at 842 in order to determine the destination county, and the corresponding destination state. Accurate street level validation is necessary since compliance rules and reports are determined according to the county and state that are associated with the destination address. In particular, address validation data bases are used to cross check street names, counties, and states, etc. As a result, if any information is invalid, or does not meet a threshold of certainty, the suspect information is marked and an alternate choice is provided for verification. For instance, if a street name is misspelled, an alternate street name with various spellings would be presented for selection by the client. As such, with proper street level validation, the present embodiment is capable of ensuring accurate compliance with each of the rules governing shipment of wines to the corresponding addresses.

FIG. 9 is an illustration of a screen shot 900 representing a user interface tool that is capable of performing street and county validation. As shown in FIG. 9, three shipments have been flagged with incorrect addresses. Shipment order 241 is associated with customer Name 1, shipment order 243 is associated with customer Name 2, and shipment order 245 is associated with customer Name 3.

For example, for shipment order 241, the original shipping address 910 contains possible errors, such as an incomplete street address, an incorrect state, and non-provided county. Possible suggestions or alternatives are provided in section 915. For instance, the suggested address is “14 Mountain Laurels Dr.”, the suggested state is “New Hampshire,” and the suggested county is Hillsborough. For shipment order 243, the street name “Bay” is suggested to be “Brunelle Ave.” For shipment order 245, the spelling of the street is suggested to be “301 Buddington Rd.” and the city name “Palmyra” is suggested to be “Worcester.” Each of the suggestions are selectable for entry before importing the corresponding order into the compliance system 100 in order to perform compliance checking

Additionally, at 844, the products in the sales order is also validated when confirming the order. For example, the specific brand, product, amounts, etc. are validated by the product verification module 137 of FIG. 1 before importing the order.

In another embodiment, age verification of the customer is performed. That is, real-time age verification is performed at the point of sale for states that require age verification. Age verification can also be performed after the point of sale to prevent delivery of wine to persons not of legal age to order and receive shipments of wine, in one embodiment.

At 850, in the present embodiment, the orders are checked for compliance. In particular, the compliance check determines compliance on all of the shipments in one or more sales orders with the rules associated with shipping wine to the associated destination addresses. The compliance checking in 850 is analogous to the compliance checking performed in 320 of FIGS. 3 and 730 of FIG. 7, in embodiments of the present invention.

As a result of the compliance check performed in 850, a summary of results can be presented. For instance, FIG. 10 illustrates a summary page 1000 indicating, in part, which shipments of the total number of orders failed. In particular, top bar 1010 provides a summary of the results, such as total orders, numbers passed, and number of orders that failed. For instance, out of 12 total orders, 7 are in compliance, and 5 are not in compliance. A complete list is also provided that lists, for each order, rules that are in compliance, and rules that are not in compliance.

More particularly, summary page 1000 provides an explanation as to why a particular order is not compliant. For example, for shipment order 235 to customer Name 4, in the explanation section 1020, it is explained that the shipment failed because the carrier is prohibited from shipping wine to Anderson, Ind. A detailed explanation is further provided as to why shipments are prohibited in this region.

In addition, possible solutions are also provided to remedy the non-compliance. For example, for shipment order 239 to customer name 5, the order failed because of noncompliance with the Customer Aggregate Volume Limit. Specifically, shipments to Name 5 have exceeded 2 cases in the calendar month. In section 1030, a possible solution is provided. Namely, the next possible shipment date is Aug. 1, 2006.

Returning back to FIG. 8, at 860, once the compliance check is completed, orders that are in compliance are submitted for execution. That is, the compliant orders are shipped to the destination address. Conversely, orders that are not in compliance are not shipped. As an advantage and benefit, in embodiments of the present invention, by running compliance checks prior to shipping so that shipped orders are in compliance with rules regulating the shipping of wine and alcohol, it is ensured that state reports are reporting only compliant data and not reporting instances of non-compliance or non-compliant data.

At 870, in the present embodiment, once orders are shipped, each shipment of wine can be individually tracked. Specifically, tracking module 170 of compliance system 100 is capable of tracking shipments. Tracking module is capable of receiving shipping information provided by each of the third party shipping agents (e.g., FedEx) that perform the physical shipment of the order. For example, the shipping information may comprise a tracking number provided by the third party shipping agent. As such, additional tracking information can be determined by examining the information associated with the tracking number.

Table 1 provides a tracking history associated with a tracking number, both of which are provided by a third party shipping agent. From the information in the tracking history, additional information can be determined. As an example, additional information could include, but is not limited to, actual ship date and time, actual delivery date and time, person who signed for the package (e.g., Name 9), total case number and weight of the package, etc. As a result, shipping problems can be determined, such as when a shipment is returned. An alert can be generated notifying a shipping client of the shipping problem. For instance, the alert 1109 of FIG. 11B notifies the shipping client when a package could not be delivered.

TABLE 1
Tracking History

| DESTINATION | TIME/DATE | DESCRIPTION |
|---|---|---|
| Lincolnshire | 9/20/06 | Delivered to |
| | 3:49:00 PM | Name 9 |
| Chicago | 9/19/2006 | Held at Sort Facility |
| | 10:26:00 PM | |
| Chicago | 9/19/06 | Arrived at Sort |
| | 9:52:00 PM | Facility |
| Oakland | 9/19/06 | Left Sort Facility |
| | 4:20:00 PM | |
| Oakland | 9/18/06 | Arrived at Sort |
| | 8:19:00 PM | Facility |
| Petaluma | 9/18/2006 | Origin Location |
| | 7:00:00 PM | |

In one embodiment, the shipping information is used to perform compliance checking and generate compliance reporting. For example, the actual delivery date for each shipment that is obtained from tracking information supplied by the shipper is used for compliance reporting. That is, instead of using the date an order was processed, a requested ship date for the order, or a projected ship date for the order, the actual delivery date is used when performing compliance checking and for generating compliance reporting, thereby giving more accurate compliance reporting information.

### 5. Providing Alerts of Interest Related to Direct Shipment of Alcohol

Additionally, the compliance system 100 as provided by alert module 150 is capable of providing alerts upon the occurrence of a triggering action, wherein the triggering action is related to the direct shipping of alcohol. As an example, these alerts can be reminders that indicate Client #1 needs to take some further action, or alerts can be used to convey information.

Alerts are used to help manage compliance with the numerous rules defining regulations related to the direct shipping of alcohol. For example, alerts are used to notify the shipping client when items are due, or when specific events occur that are important to the client in relation to direct shipping of alcohol. For example, alerts are used to manage licenses, brand registrations, reports, volume limits, and delivery of packages, etc. In addition, alerts are used to provide information on new rules, changes to rules, returns of packages, etc.

Alerts are provided upon the occurrence of a triggering action. As such, tracking of the triggering actions are also performed by the compliance system 100. These triggering actions can be user defined. Some examples of triggering actions are listed below and are not intended to provide an exhaustive list. For instance, alerts requiring some further action are associated with the occurrence of the following triggering actions: when an expiration date of a license associated with the shipping client is within a threshold period (e.g., one month); when an expiration date of a brand registration associated with the shipping client is within a threshold period; or when a due date for a report associated with the shipping client is within a threshold period. Alerts providing notification of important information are associated with the occurrence of the following triggering actions: when a new rule takes effect; when a rule has been modified; when a volume limit associated with the shipping client is within a threshold amount; or when a package associated with one of the plurality of direct shipping orders has been returned.

FIG. 11A provides an illustration of a tool of a user interface 1100A for showing alerts related to compliance with rules regulating the direct shipment of alcohol, in accordance with one embodiment of the present invention. As shown in FIG. 11A, a priority can also be given for each of the alerts. For example, priority stages include low, medium, or high. Other embodiments are well suited to other types and numbers of priority stages.

Further, additional user actions can be taken with regards to each action. For instance, a snooze feature with a selectable time for snoozing is provided for each alert. For instance, snooze button 1112 can be selected to snooze the alert in block 1110 for 30 minutes. In addition, a dismiss selector is provided that when enabled indicates a dismissal of the corresponding alert. For instance, once Client #1 completes and submits the Connecticut Direct Shipping Report shown in block 1110, a dismissal of the reminding alert is implemented by selecting button 1113.

Blocks 1110 and 1120 illustrate high priority alerts. For instance, in block 1110, the high priority alert notifies Client #1 that a Direct Shipping Report for the state of Connecticut is due within 0 days. Also, in block 1120, the high priority alert notifies Client #1 that a Wholesale Alcoholic Beverage Tax Return for Connecticut is due within 0 days.

Blocks 1130, 1140, 1150, 1160, 1170, 1180, and 1190 illustrate medium priority alerts. Each of the alerts in these blocks notifies Client #1 that a brand registration will expire in corresponding states. For instance, the brand registration for Captain will expire in 31 days in Nevada, Connecticut, and North Carolina as indicated in blocks 1130, 1140, and 1150.

FIG. 11B is an illustration of a tool illustrating a user interface 1100B that defines parameters for associated alerts, in accordance with one embodiment of the present invention. As shown in FIG. 11B, the plurality of alerts 1105 has an associated expiration alert 1115, a rule change alert 1125, and a new rule alert 1135. Not all of the rules require all of the alerts. In general, the triggering action and priorities of the alerts can be user defined and be applicable to all states, in one embodiment.

For example, for rule 1107 pertaining to the requirement of a brand registration, a priority and reminder triggering action are user defined for the expiration alert 1115. That is, a medium priority is defined for the expiration alert 1115 for rule 1107. Also, a triggering action of a 1 month reminder is defined from the expiration alert 1115.

In addition, a rule change alert for rule 1107 is given a medium priority. As such, whenever the corresponding rule is modified by the state legislature, an alert will be generated and be given a medium priority. Further, a new rule alert is given a medium priority for rule 1107. As such, whenever the corresponding rule is created by the state legislature, an alert will be generated and be given a medium priority.

### 6. Generating Reports Related to Direct Shipment of Wines

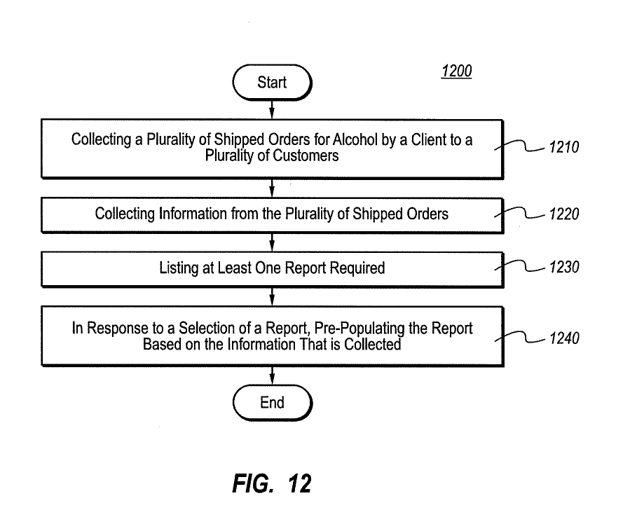

FIG. 12 is a flow diagram 1200 illustrating a method for automatically generating reports that are required when making shipments of alcohol (e.g., wine). Reports are required by the various local, state, federal, and other agencies. The reports include Direct Shipping Reports, Tax Reports, etc. Each of these reports include information that is collected, analyzed, parsed, and tabulated from the orders placed and executed for delivery of alcohol. In particular, the method of flow diagram 1200 is capable of automatically generating electronic versions of the reports in various formats that are ready to print, sign, and submit to the corresponding agency.

At 1210, in the present embodiment, a plurality of shipped orders is collected. The plurality of shipped orders are for the shipment of alcohol (e.g., wine) by a shipping client to a plurality of customers. In one embodiment, the plurality of shipped orders are imported into the compliance system 100 by the importing module 120, as previously described in relation to FIGS. 1, 7, and 8.

At 1220, information is collected from the plurality of shipped orders. Specifically, all pertinent reporting information required for generating reports, as well as any additional information, are collected. For example, sales tax information for each order is collected in order to generate sales tax reports required by various government agencies.

The collected information is stored for future retrieval. For example, orders, invoices, and information collected from the orders and invoices are stored. In one embodiment, the collected information is stored in storage module 110.

At 1230, in the present embodiment, a list is presented from which reports can be generated. For example, the list contains at least one report that is required by government agencies to which orders for alcohol potentially or has been shipped.

At 1240, the report is automatically generated. That is, in response to the selection of one report in the list of reports, the selected report is pre-populated with information. In one embodiment, the information has been previously collected at 1220. In another embodiment, the information can include orders whose payment has been received, but has not been shipped. In this case, a sales tax report can be generated, but an excise tax report is unnecessary since the order has not shipped. In still another embodiment, pre-population may require further analysis in some cases. For example, tax information gathered from a plurality of orders may be aggregated to generate a tax report for a state.

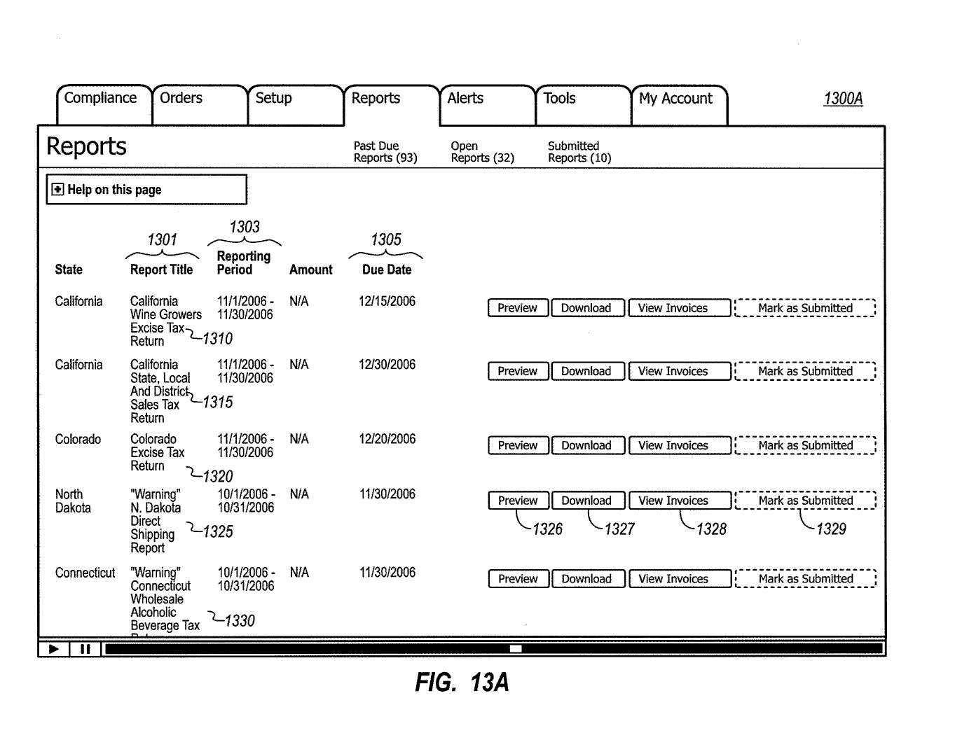

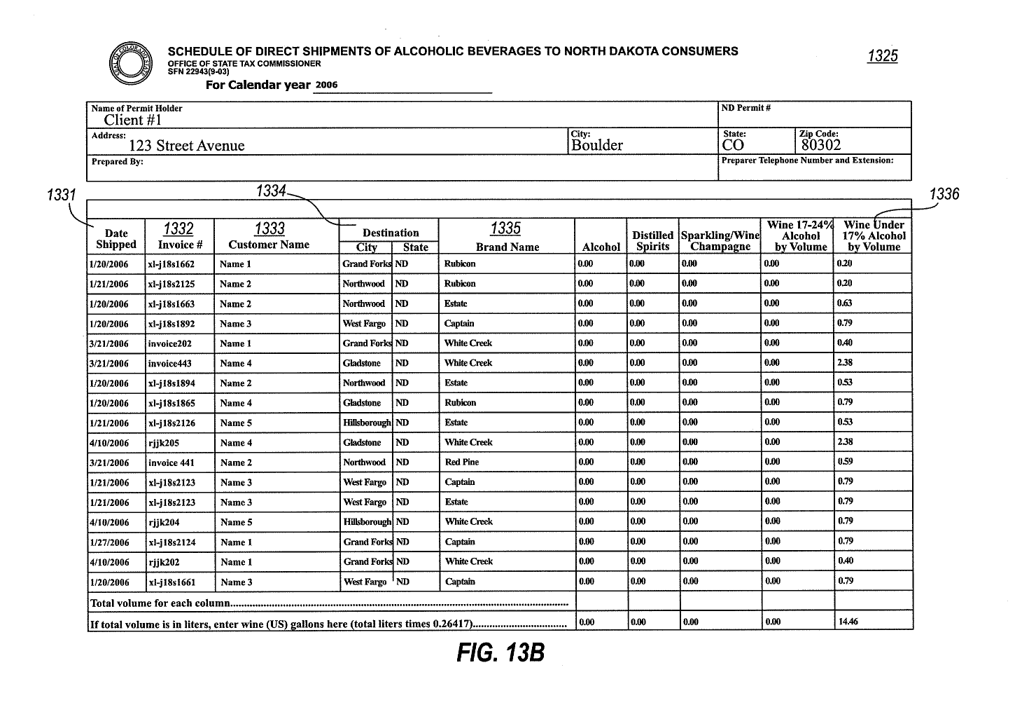

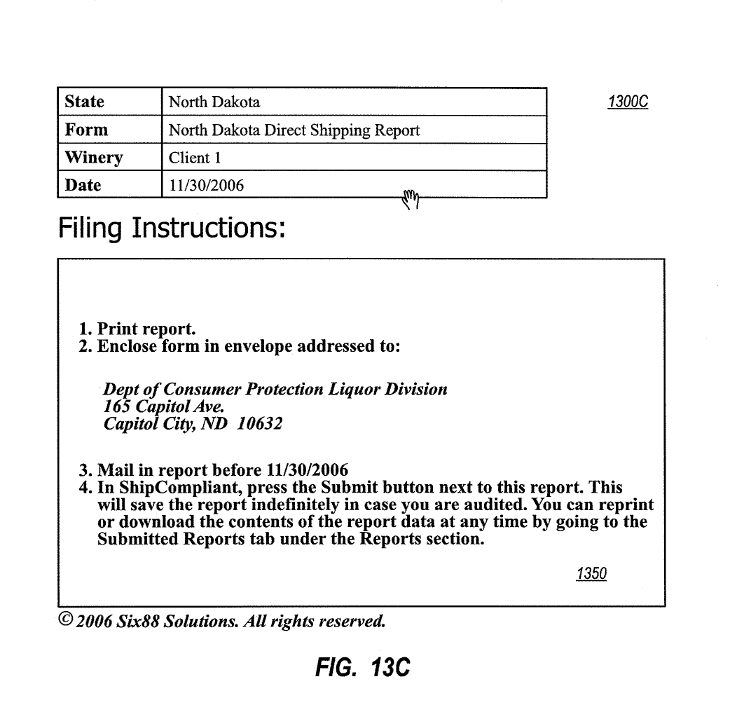

FIG. 13 A is a diagram of an exemplary list 1300A that provides a plurality of reports that are required by regulating agencies, such as various state agencies that regulate the direct shipment of alcohol. By way of example, list 1300A shows a partial list of report titles in column 1301, and includes California Wine Growers Excise Tax Report 1310, California State, Local and District Sales Tax Return Report 1315, Colorado Excise Tax Return, 1320, North Dakota Direct Shipping Report 1325, and Connecticut Wholesale Alcoholic Beverage Tax Return, 1330. Other reports can be included in the list 1300A.

Various information and selections are provided for each of the reports provided in list 1300A. For instance, the reporting period is included in column 1303, and the due date is provided in column 1305. Additionally, selection buttons are provided. For example, for the North Dakota Direct Shipping Report 1325, a PRINT button 1326, a DOWNLOAD button 1327, a VIEW INVOICES button 1328, and a MARK AS SUBMITTED button 1329 are provided.

Selection of the PRINT button 1326 or the DOWNLOAD button 1327 automatically generates a completed report. For instance, selection of the print button 1326 implements the automatic generation of the North Dakota Direct Shipping Report with pre-populated information, and prints a hard copy that is ready to be signed and submitted to the corresponding state agency.

Additionally, selection of the DOWNLOAD button 1327 also automatically generates the pre-populated North Dakota Direct Shipping Report, and downloads the electronic version to the designated location. In one embodiment, if information in the shipping report has changed since its submission, then a warning message is generated and displayed for the user indicating that information in the shipping report has changed. The user can then choose to research the issue further if necessary.

For example, FIG. 13B is an illustration of the North Dakota Direct Shipping Report 1325 that is automatically generated for Client #1, in accordance with one embodiment of the present invention. The Report 1325 is pre-populated with the information listed in each of the columns. For instance, pre-populated information includes, in part, shipping date in column 1331, the invoice number in column 1332, the customer name in column 1333, the destination of the shipment in column 1334, the brand name in column 1335, and the amount of wine provided by volume in column 1336.

In one embodiment, each of the reports that are automatically generated are also stored. For instance, the generated reports are stored in storage module 110. The reports can be stored for any period of time, such as the time for storage required by the each of the corresponding states.

In addition, once the report is automatically generated, instructions for filing the report with the requiring agency are provided, in accordance with one embodiment of the present invention. For example, FIG. 13C is an illustration of a screen shot describing filing instructions necessary to submit the North Dakota Shipping Report 1325 with the requiring state agency. As shown in block 1350, complete instructions are provided. In step 1, the instruction provides for printing the North Dakota Shipping Report 1325. At step 2, the instruction provides the address of the requiring state agency, the Dept. of Consumer Protection Liquor Division. In step 3, the instruction provides mailing instructions. In step 4, instruction is for saving and storing the report.

In one embodiment, a bulk report download feature is enabled. Specifically, activation of a single button generates a single download of all due reports and their schedules. As a result, all due reports can be printed in preparation for sending to their respective reporting jurisdictions without the user specifically knowing that a report is due for any particular agency.

Accordingly, embodiments of the present invention provide for automatic compliance checking of rules regulating the direct shipping of alcohol (e.g., wine). In addition, other embodiments of the present invention provide for automatic generation of agency required reports related to the direct shipping of alcohol (e.g., wine). Still other embodiments provide for the generation of alerts for alerting when reports are due, licenses are up for renewal, volume totals are approaching limits, regulatory changes occur, etc.

While the methods of embodiments illustrated in flow charts 3, 7, 8, and 12 show specific sequences and quantity of operations, the present invention is suitable to alternative embodiments. For example, not all the operations provided for in the methods presented above are required for the present invention. Furthermore, additional operations can be added to the operations presented in the present embodiments. Likewise the sequences of operations can be modified depending upon the application.

A method and system for automatically checking compliance with rules that define regulations for direct shipping of alcohol, is thus described. While the invention has been illustrated and described by means of specific embodiments, it is to be understood that numerous changes and modifications may be made therein without departing from the spirit and scope of the invention as defined in the appended claims and equivalents thereof. Furthermore, while the present invention has been described in particular embodiments, it should be appreciated that the present invention should not be construed as limited by such embodiments, but rather construed according to the below claims.

What is claimed is:

1. A computer-implemented method of compliance checking, comprising:
using a specially-programmed computer, defining a set of rules related to shipping alcohol to a region;
using an automated computer-implemented process, determining if a shipping client associated with a plurality of direct shipping orders to said region is compliant with each of said set of rules; and
indicating, using a computer network, whether said shipping client is compliant with said set of rules.

2. The method of claim 1, wherein said defining a set of rules comprises:
defining said set of rules related to shipping alcohol comprising wine.

3. The method of claim 1, further comprising:
defining said set of rules for said region comprising a state.

4. The method of claim 1, wherein said indicating whether said shipping client is compliant comprises:
presenting a color coded representation of a compliance status of said shipping client when executing said plurality of direct shipping orders in relation to said set of rules.

5. The method of claim 1, wherein said determining if a shipping client associated with a plurality of direct shipping orders to said region is compliant comprises:
determining compliance if said plurality of direct shipping orders is compliant with said set of rules; and
determining non-compliance if one of said plurality of direct shipping orders is not compliant with one of said set of rules.

6. The method of claim 1, wherein said indicating whether said shipping client is compliant comprises:
listing rules that said shipping client is in compliance; and
listing rules that said shipping client is not in compliance.

7. The method of claim 1, wherein said indicating whether said shipping client is compliant comprises:
for a rule in said set of rules, providing a definition of said rule;
for said rule, providing a compliance status of said shipping client when executing said plurality of direct shipping orders.

8. The method of claim 1, wherein said determining if said shipping client is compliant comprises:
determining if said shipping client is compliant when executing said plurality of direct shipping orders comprising a plurality of onsite direct shipping orders.

9. The method of claim 1, wherein said determining if said shipping client is compliant comprises:
determining if said shipping client is compliant when executing said plurality of direct shipping orders comprising a plurality of offsite and onsite shipping orders.

10. The method of claim 1, further comprising:
alerting an occurrence of a triggering action related to the direct shipping of alcohol.

11. The method of claim 10, wherein said triggering action is taken from a group consisting of:
when an expiration date of a license associated with said shipping client is within a threshold period;
when an expiration date of a brand registration associated with said shipping client is within a threshold period;
when a due date of a report associated with said shipping client is within a threshold period;
when a new rule takes effect;
when a rule has been modified;
when a volume limit associated with said shipping client is within a threshold amount; and
when a package associated with one of said plurality of direct shipping orders has been returned.

12. The method of claim 1, further comprising:
defining at least one rule in said set of rules that is related to shipping alcohol to another region;
determining if said shipping client is compliant with said at least one rule when executing direct shipping orders to said another region; and
indicating whether said shipping client is compliant with said at least one rule.

13. A computer-implemented method of compliance checking, comprising:
receiving over a communication network at a server associated with a web service implementing said method of compliance checking, an order for shipping wine to an address of a customer;
determining a set of rules related to shipping wine to said address;
using a specially-programmed computer, determining if said order is compliant with each of said set of rules;
indicating, through a computer network, whether said order is compliant with each of said set of rules.

14. The method of claim 13, wherein said determining a set of rules comprises:
validating a street of said address; and
validating a county associated with said address.

15. The method of claim 14, further comprising:
automatically providing an alternate street for client verification if said street is not valid; and
automatically providing an alternate county for client verification if said county is not valid.

16. The method of claim 13, wherein said indicating whether said order is compliant comprises:
providing, through the computer network, an explanation as to why said order is not compliant with said set of rules.

17. The method of claim 16, further comprising:
providing, through the computer network, a solution for said order to be compliant with said set of rules.

18. The method of claim 13, further comprising:
shipping said order if said order is compliant with each of said set of rules; and
not shipping said order if said order is not compliant with each of said set of rules.

19. A method of compliance reporting, comprising:
collecting over a communication network at a server associated with a web service implementing said method of compliance reporting a plurality of shipped orders for alcohol by a client to a plurality of customers;
collecting information from said plurality of shipped orders; and
listing at least one report required by agencies regulating the shipment of alcohol; and
in response to a selection of a report, automatically pre-populating said report based on said information that is collected.

20. The method of claim 19, wherein said collecting information comprises:
collecting sales tax information for said plurality of shipped orders.
